(19) United States
(12) Patent Application Publication
(10) Pub. No.: US 2006/0260754 A1
(43) Pub. Date: Nov. 23, 2006

(54) System and method for generating intermediate variable pressure sensitive webs

(75) Inventor: Jesse D. Crum, Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/151,571

(22) Filed: Jun. 13, 2005

Related U.S. Application Data
(63) Continuation-in-part of application No. 11/135,481, filed on May 23, 2005.
(63) Continuation-in-part of application No. 11/135,179, filed on May 23, 2005.
(63) Continuation-in-part of application No. 11/135,131, filed on May 23, 2005.

(51) Int. Cl. B32B 38/14; B32B 37/00; B32B 38/04

(52) U.S. Cl. 156/387; 156/378; 156/379; 156/519; 156/552

(57) ABSTRACT

The present invention relates to a unique system that can create pressure sensitive laminate web having either random or regular patterns of discontinuous surface elements or segments that are individually disposed on a surface of a web of material. The surface elements are first printed or imaged, preferably with a high quality imaging device, then cut into individual segments and placed sequentially on a moving web. The intermediate arrangement created by this system ranges from a series of overlapping or shingled ribbons to a regularly spaced configuration of discrete pieces on a web to randomly generated patterns. The resulting intermediate assembly may then be used for a number of uses including prime label applications, marketing or promotional activity and other forms of business communications.

### CROSS-REFERENCES TO RELATED APPLICATIONS

This application is a continuation-in-part of application Ser. No. 11/135,481 filed May 23, 2005, Ser. No. 11/135,179 filed May 23, 2005 and Ser. No. 11/135,131 filed May 23, 2005 the disclosures of each of which including that found in the claims is incorporated herein by reference.

### FIELD OF THE INVENTION

The present invention is in the field of composite, intermediate manufacturing systems that are used in the preparation of articles, such as pressure sensitive laminates that may be used in the production of prime labels, tags, cards, magnetic components and the like. The system of the instant specification may include a computer for selecting a template arrangement from one or more groups of pre-determined templates, and for communicating with an image generation device and placer mechanism to prepare a web assembly having a number of discrete segments deposited on a web to form a discontinuous surface assembly. The image generation device is used for rendering typically a graphical depiction on one or more surfaces of the areas of the templates that can be configured from a particular sheet or substrate. A placer or inserter is used for placing the templates or segments on a continuous web that is being handled by a web processing apparatus.

The templates, which represent an area that can be used for labels, tags, cards, etc. of the present invention, are produced in part, initially from a pre-imaged or pre-printed sheet that is then converted or merged to a roll type of format through use of a novel placer mechanism. The sheets are printed with high quality graphics or images which are then slit or cut to size to form templates, ribbons, surface elements or segments for the particular application. The segments are then converted to or merged with a continuously advancing web to create a continuous roll format. Then the segments that have been affixed to the web are provided in one or more intermediate configurations to an end user typically for application for instance to consumer packaged goods. More particularly, the pressure sensitive laminates of the instant application can be used to create individual, prime labels having a high or photo quality resolution level such as those about 300 lines per inch or approximately 2500 to 3500 dots per inch.

### BACKGROUND OF THE INVENTION

Today, there are wide varieties of product offerings available that serve multiple purposes and functions, including product offerings that are used in fulfilling needs such as in the prime label market. However, there are a number of other web configurations that may be used in preparing business communication assemblies and other constructions that are used to convey or handle information.

Conventional processes that are used today, for example, in creating prime labels and other pressure sensitive label configurations are typically based on a continuous web technology that uses flexographic presses. The process includes the feeding of a continuous web of material, such as a preformed web of pressure sensitive laminate which normally consists of a top ply having a layer of adhesive on its underside that is covered by a release liner to form the laminate assembly through the press. The web is then processed through a press, typically a flexographic press, and an image is applied to the web by various stations. The web may then be collected, die-cut and the individual labels removed and applied.

Flexography is commonly used today for the printing of decorative items including the rendering of packaging and employs a series of plates and one or more stations, containing inks, to apply colored images to the web as the web traverses the press. Through improvements in ink qualities and other modifications and enhancements in the technology, the image quality in flexographic presses and resulting products has improved to about 150 lines per inch.

Typically, for a point of reference, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms in cooperation with electronic scanners and image setters to produce halftone images that are to be subsequently used to render an image. The pixels of digitized images are first assembled into dots that are then used to form shapes, sizes, rulings, etc. which create the ultimate image produced on the substrate.

While flexographic technology or flexography is desirable for use in such printing due to the economies that can be achieved when compared with other types of printing processes, such as lithography, there are a number of drawbacks in utilizing this process for certain applications. Initially, the quality is limited, despite improvements in the technology to about 150 lines per inch. This can make some complicated graphics appear “grainy”. Other images, such as those that use flesh tones or deep or rich colors, may look faded or “washed out”. The effects of this level of image resolution can detract from the product appearance which may diminish the value of the technology and the products produced particularly for the prime label market. With increasing sophistication of consumers, as well as technology and expectations from each, such effects may be undesirable to potential end users.

Flexography also suffers from other drawbacks, such as the time that is involved in preparing a production job to run or “make ready” as it may otherwise be known in the industry. That is, the steps that are used to prepare the flexography equipment for running a particular job or order. This “make ready” process includes such activity as the preparation of multiple plates to produce the image at each station, mixing inks, calibration and alignment of the images between stations and the like. Operation of the flexography presses may also include multiple operators which can add to manufacturing costs. In addition, waste can also be a problem with such conventional printing technologies in that a number of feet, yards or meters of web material must be processed through the press in order to have the colors reach a predetermined threshold and to ensure appropriate registry of the stations as they are printing the images on the web. The amount of material wasted can be several times the length of the press or up to several hundred feet of material. The use of such volumes of materials obviously increases the cost of the operation. Thus, due to the make ready process and waste factors, the production of products (e.g. prime labels) through the use of flexography may then be limited to serving only certain market segments, namely large market segments. Markets that are applicable for this technology segment are generally believed to be those orders for large quantities of several hundred thousand or millions of pieces, which potentially leaves the smaller label market, e.g. 100 to 1,000,000 labels, unfulfilled or at least not adequately served by currently available technologies due to cost and materials thresholds.

Another drawback believed to be associated with flexographic technologies is that the technology cannot provide any variability in the product, including such basic functionality as sequential numbering, addressing or adding promotional text in connection with a seasonal advertisement or other offering without the addition of further processing stations. If such features are required by an end user or customer, such as with product date or coding, this function generally cannot be performed by flexographic presses without the inclusion of additional stations. Instead, these features typically must be achieved through an off line operation, such as ink jetting, often after the label has been applied to the container or carton. Alternatively, the ink jetting may be performed directly on the container as part of a separate operation.

Flexographic presses normally have a number of pre-determined stations. For example a four color press may have only four stations that can be used to treat or process the web. Thus, if other stations are to be added, such as a numbering head, the manufacturer likely then has to reduce the number of colors that can be added to the web as one station has been surrendered for the numbering head.

Flexographic technology also limits the ability to add personalization to products produced on such presses. This may be particularly desirable in certain market segments where such prime label products on consumer package goods (“CPG”) may further enhance the product or service offering by making the product more attractive to prospective purchasers, thereby increasing the appeal to the consumer of the product or service.

Identifiers such as labels, business cards or tags may also be readily rendered using desktop equipment. While the resolution may be slightly improved when compared with conventional flexographic technology, speeds of application are significantly reduced as the images are processed in a sheet wise fashion on desktop equipment. This results in only a few sheets per minute being produced as opposed to hundreds of feet per minute that are commonly capable of being processed by flexographic equipment. That is, the desktop unit may only handle and print one sheet at a time before the next sheet is advanced for printing or imaging when compared with a conventional web fed process which produces sheets at a faster rate. Thus, in using such a desktop process one may only be able to render a handful of sheets per minute as opposed to a flexography operation that may process several hundred feet per minute. Use of desktop processes is thus not likely efficient in trying to generate hundreds and certainly not thousands of labels, but may be useful in creating a few dozen labels for very small applications such as a small home or small office environment.

What is needed, therefore, is a template generation system by which high quality graphics can be used to create products for a number of distinct applications. For example, graphics having a resolution in excess of about 150 lines per inch can be produced in an efficient and cost effective manner, such as in a continuous system operating at greater than fifty feet per minute. Moreover, a system which can add substantial variability to the product as well as other features, such as embossments, over laminates, variable printing or imaging and the like, would greatly expand the penetration of this form of business communication in the marketplace. The present invention seeks to provide an intermediate assembly that is capable of having a number of different surface configurations, e.g. labels, cards, tags, plastics, films and the like. The surface configurations, which will consist of a series of discrete individual elements will each have printing or imaging that includes graphical or resolution quality of about 150 or more lines per inch and preferably more than 300 lines per inch, which is approximately equal to about 2500 to 3500 dots per inch (“DPI”) in order to create a high quality image product that is intended to be aesthetically appealing to the consumer and to more effectively communicate the business message of the application.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been discovered that there is no readily available process or system by which a manufacturer can create high quality printed form product templates, in a continuous process with each of the templates or ribbons each having significantly improved graphic resolution that is greater than about 150 lines per inch, preferably greater than about 200 lines per inch and still more preferably about 300 lines per inch, in an efficient and cost effective manner. Through the development of the present system and the creation of the unique intermediate web assembly described in this invention, the manufacturer can now service a particular niche market segment for creating high quality templates in a continuous fashion, such as those ranging from approximately 100 to 1,000,000 prime labels. While the foregoing market size or segment is a target area of the present invention, it should be appreciated that the invention may be practiced and used to fulfill larger order quantities, such as those of a million or more.

The pressure sensitive intermediate of the present invention is created through a unique sheet to roll process which provides savings specifically through reduced make ready time and generation of waste material and yields a higher image resolution product when compared with conventional processes such those produced by using conventional flexographic technologies.

The present invention uses previously prepared individually created sheets, or segments, that have imaging or printing already applied to the sheets, e.g. graphical depictions, before the sheets are provided to the manufacturing press. The printing is provided in pre-defined areas, determined prior to production, to create individual segments than can be used for a number of purposes. The templates or segments are then cut from the sheet and supplied to a feeder mechanism. The templates, sheets, ribbons or segments are then applied to the web in a number of patterns, including substantially edge-to-edge configuration, with a slight overlap or alternatively, provided in regularly occurring increments depending on the needs of the particular application to be serviced. In addition, the product produced in connection with the present process described in the instant application is also not limited in functionality as a number of materials, operations and options may be used in creating a relatively dynamic product. Such additional processes may include variable printing, embossments, coatings, over laminates and the like.

By preparing the intermediate prime label assembly in the manner described herein, the intermediate web can be processed continuously at speeds of greater than 50 feet per minute, preferably between 75-150 feet per minute and still more preferably at speeds of about 200 feet per minute or greater.

The system of the present invention can be used in the creation of a number of unique products such as webs that carry a series of labels, tags, cards, magnetic pieces, films and the like or mixtures of these elements. For example, a web can consist entirely of label segments or templates, or can have alternating and regular repeating arrangements of labels. Another element, such as cards may have complete variability such that multiple elements are laid down in a particular sequence (label, card, magnetic, etc.) on a web.

In one exemplary embodiment of the present invention a system for generating variable intermittently laminated pressure sensitive webs is described and includes a series of product imprint groups. Each group has a number of pre-determined templates, each of the templates has an area that receives printing or imaging and each of the group of templates are configurable from a sheet of stock material. A computer is used for selecting at least one of the groups in connection with a request to produce a printed product. The computer determines a placement sequence for the templates and communicates with a web processing apparatus and a placer mechanism to deposit the templates on a continuously advancing web assembly.

The system also includes an imaging device that is used for producing graphical and textual depictions in the area of each of the templates while the templates are in the sheet configuration. The sheet is cut by a cutter device into individual templates that will be used for placement on the web. A web processing apparatus is used for handling a continuous web of material, and a placer mechanism is also included with the system of the presently described embodiment to place the templates on the web.

Continuing with the description of the present embodiment, after printing, in response to a signal, the placer mechanism sequentially places each of the templates in accordance with the placement sequence generated by the computer on the continuous web of material to create a web having a series of discrete templates serially laminated thereon.

In a further exemplary embodiment of the present invention, a system for creating a pressure sensitive laminate web having multiple discontinuous surface elements, is described and includes a continuous web processing apparatus for handling a continuous web. The continuous web has a release coating and pattern of adhesive disposed over the release coating. The continuous web processing apparatus is used to advance the continuous web in a machine direction and through at least one processing station, such as the placer station. Other stations such as variable printing, coating, laminating and additional placers may also be used in connection with the present system.

The system of the presently described embodiment includes an image generating device for applying imaging or printing to a sheet of stock material. The image generating device is programmed to render discrete areas on the sheet in order to create individual elements that will be cut from the sheet and applied to the continuous web.

A series of previously prepared surface elements is used in connection with the present embodiment with each of the elements having imaging or printing applied thereon. The surface elements are cut from the sheet of stock material after printing or imaging.

The system further includes a placer mechanism for applying each of the surface elements to the continuous web while the web is handled by the continuous web processing apparatus. The placer mechanism sequentially places each of the surface elements on the continuous web to create a pressure sensitive laminate web having discrete, discontinuous surface elements applied thereto.

In a yet still further embodiment, a system for creating a pressure sensitive web having a number of individual sheet segments affixed to a continuous web is described and includes a web processing device for handling a continuous web. The continuous web has first and second faces and first and second longitudinally extending sides and a release coating applied between the first and second longitudinally extending sides on the first face. The continuous web further has a pattern of adhesive applied over the release coating to create a pressure sensitive web assembly.

The system also includes an image generating device for printing or imaging graphical depictions on a surface of a sheet of material in discrete areas. Each of the areas defines individual sheet segments that will ultimately be placed on the web. Examples of image generating devices include high resolution imaging devices such as Indigo®, available from Hewlett Packard of Palo Alto, Calif. or Karat available from KBA of Williston, Vt. Ideally, the present invention seeks to provide a segment or intermediate with a series of segments that has a quality of about 150 or more lines per inch and preferably more than 300 lines per inch, which is approximately equal to about 2500 to 3500 dots per inch (“DPI”) in order to create a high quality image that is intended to be aesthetically appealing to the consumer.

A cutting device is also included in the present system and is used for cutting the sheet into individual sheet segments after the sheets have been printed or imaged by the image generating device. Such a cutting device may include a die cutter, laser die cutter, slitter, guillotine or other devices that can separate the templates from the sheet.

Continuing with a description of the present embodiment, a placer mechanism is used for sequentially depositing the individual sheet segments on the continuous web. The placer mechanism is activated in connection with a signal and the mechanism deposits the sheet segments between the first and second longitudinally extending sides of the continuous web. The sheet segments in connection with the continuous web create a pressure sensitive laminate continuous web assembly that has a number of pre-printed, separate sheet segments that are applied to the first face of the continuous web.

The elements, segments or templates that are used in connection with practicing the present invention may be composed of any suitable material such as plastic, magnetic, labels, cards, foils, films and combinations thereof.

The system of the present invention can be used to create intermediate web assemblies that have regular patterns of surface elements, random configurations or other pre-determined arrangements of templates or segments that may be used to communicate a particular marketing message or business communication.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a schematic of one embodiment used in creating the intermediate pressure sensitive web of the present invention;

FIG. 2 presents a further schematic of the system used in carrying out the invention and showing the generation of varying surface elements for affixation to a continuous web;

FIG. 3 shows a regular pattern of surface elements applied to a web in accordance with one embodiment of the present invention;

FIG. 4 illustrate a repeating pattern of different individual templates or surface elements applied to a web in accordance with the present invention; and

FIG. 5 depicts a further embodiment showing a random sequencing of surface elements on a continuous web as prepared in connection with the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The term “patterns” as used herein refers to strips, lines, shapes, spots, dots, elements and discontinuous segments, as well as regular and irregular placement of such items. Patterns may also refer to combinations of the above-mentioned items such that one pattern may be a continuous strip; another, segmented elements; and a still further an irregular placement of elements or the like. Any combination of patterns is possible depending on the need or application of the manufacturer or the end user. In addition, the pattern can be prepared in order to accommodate a particular theme, season, event, trade dress, graphics, alpha and numeric characters, and the like. Patterns are used in connection with the present invention to describe the placement of the label segments or ribbons applied to the web or individual prime labels positioned on the web in a particular pattern or arrangement. Pattern as defined herein also is used in connection with the adhesive that is applied to the continuous web.

As used herein the term “business communication piece or document” is used to refer to a substrate that, either alone or in combination with other documents can convey a particular message, image or provide information about a particular product or service that is available from the provider of such pieces or documents. Business communication documents or pieces can include advertising, sales and marketing collateral and such other items used to convey information on written or imaged form sheets, brochures, presentation folders, informational sheets and combinations thereof.

The term “personalized information” refers to information that is printed or imaged onto a substrate which is generally variable or unique and which may change from document to document or segment to segment so as to create a customized message or communication for each recipient. Examples of personalized information may include names, addresses, descriptions, plans, coding, numbering, promotional text, etc. that may have been acquired from the intended recipient through surveys, questionnaires or answers given to various inquiries generated in response to a request for goods or services.

The term “static or fixed” information refers to printed or imaged information that generally does not change from document to document or segment to segment and may include a general description or body of information about particular products, services, places, etc. that may be of interest to the intended recipient and represents a standard message that the manufacturing or supplier wishes to convey to an end user or customer of the offering.

The term “intermediate” as used herein refers to a product that undergoes one or more processing steps prior to the intermediate reaching a final condition, that of being ready for end use or application. The additional processing steps may include printing, imaging, folding, sealing, separating, cutting, perforating, scoring, adhering and the like. Typically, a product such as with the present invention is provided in an intermediate condition so that a user can add or manipulate the intermediate to create the final or desired end product, such as applying the prime label to a container, carton or the like. Thus, in accordance with the present invention, the intermediate segment for example, could be subject to die cutting or additional printing, such as through ink jetting, over laminating, coating or embossment, and then applied to a container, carton, consumer package good or the like.

The term “sheets” or “segments” as used herein refers to sheets, segments, ribbons, strips, pieces, parts, sections, subdivisions and combinations thereof. The sheet or segment provided as an example for the purposes of this specification can be an entire sheet such as 8½″×11″, 11″×14″, 19″×25″ and other known sheet sizes or may be segments, divisions, strips, etc. of such sheets. For example, a 19″×25 sheet may produced with five rows of labels, with each row having six labels, with each label having dimensions of approximately 3″×4″. For instance, in this example, each row may comprise an individual segment or sheet that may be used in practicing the present invention. It should however be understood that the invention is not to be so limited to the foregoing configuration and that individual pieces or elements, regardless whether the piece or elements have a regular or irregular shape, may be used in connection with this process to produce the intermediate assembly that is described in this application.

As used herein, the term “templates” or “element” refers to a particular size, configuration or arrangement of a piece. For example, if the template or segment is a label, the label may have a size of 2×4, 1×2 and other sizes that may be customarily produced. Likewise, if the piece is a card, the card may have a size ranging from 3×5, 2×4 or any other suitably sized card. The term templates can be used to refer to segments, ribbons and similar terms.

Through use of the present invention, a vast array of identifiers, e.g. labels, tags, cards, plates, magnets, etc. can be placed on an adhesive coated web and then collected for later use, thereby creating a versatile pressure sensitive intermediate web assembly. Through the use of the foregoing process a manufacturer may create inumerable high quality graphics, illustrations and variable and personalized text and indicia to create a greater impact on the potential consumer or end user. The foregoing process has a number of benefits over conventional technologies in that the process can occur at roughly equivalent press speeds and may be handled by conventional label applicators.

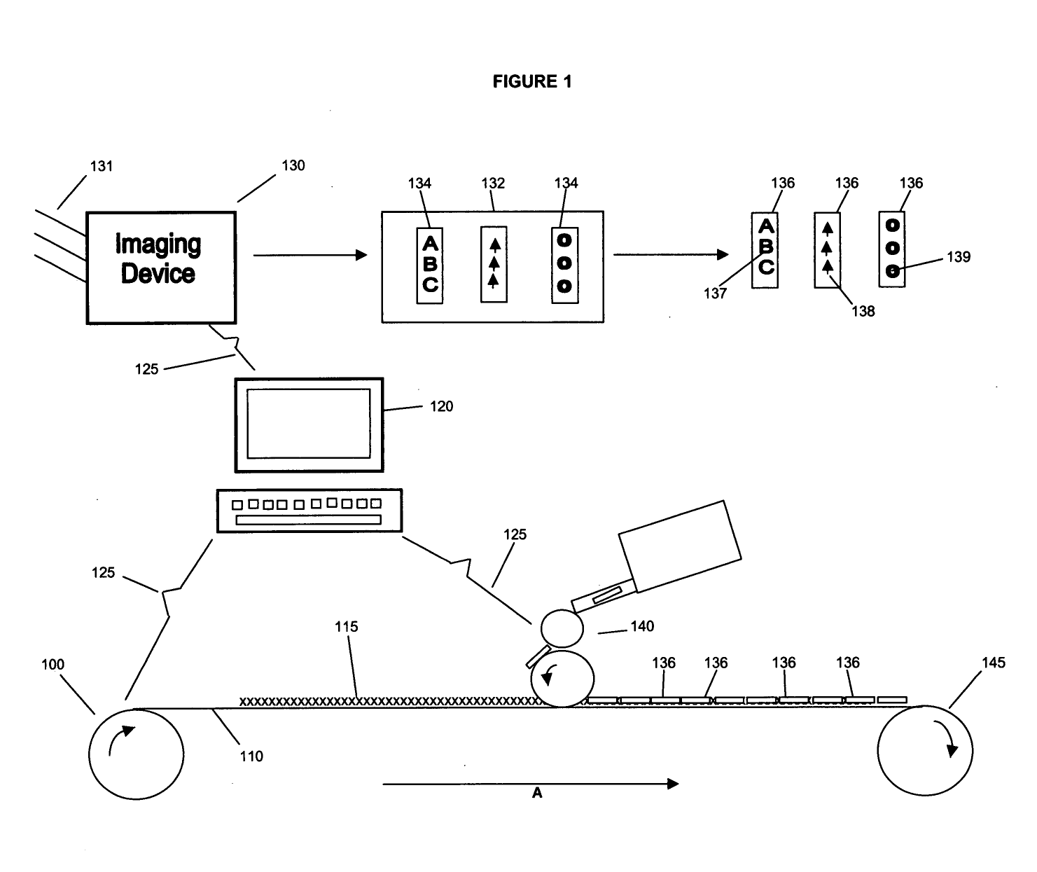

Turning now to FIG. 1, a representative schematic of the system used in carrying out the present invention is provided. The system includes a continuous web processing device 100 which is used for handling a continuous web 110. The continuous web 110 has a release coating applied to the face of the web (not shown) and a layer of adhesive applied over the top of the release coating 115 which is depicted by the use of “xxxx's”. The adhesive will preferably be a permanent type pressure sensitive adhesive, although other adhesive types are of course suitable for use with this invention, such as removable and repositionable.

The continuous web is preferably selected from a highly calendared, cellulosic based stock. The release coating is provided on the first face of the web such that when an adhesive is applied, the adhesive will transfer to the back of the segments or sheets when the individual segments are removed from the web. This will occur as the adhesive has a greater affinity for the segments or sheets than for the carrier web as the segments do not have a release coating applied to the surface in contact with the adhesive.

A computer 120, such as a personal computer is linked to the web handling press 100, imaging device 130 and placer mechanism 140 through communication means 125 such as a local area network, wide area network or global communications platform. The computer will be used in configuring a particular order, determining placement and layout of the individual templates or segments on a sheet. In addition, it should be understood that multiple computers may be used in connection controlling the system of the present invention and each significant apparatus, placer 140, press 100 and imaging device 130 may have their own computer control device. Where separate computers are provided they may be connected to one another or may operate somewhat independently.

The imaging device 130 in FIG. 1 as mentioned previously include high resolution imaging devices such as Indigo®, available from Hewlett Packard of Palo Alto, Calif. or Karat available from KBA of Williston, Vt. Ideally, the present invention seeks to provide a segment or intermediate with a series of segments that has a quality of about 150 or more lines per inch and preferably more than 300 lines per inch, which is approximately equal to about 2500 to 3500 dots per inch (“DPI”) in order to create a high quality image that is intended to be aesthetically appealing to the consumer.

The printing may be applied to one or both sides of the sheet stock and the individual segments may be positioned on the web in a printing side up, printing side down or if the printing is on both sides then one of the printed faces will be in contact with the adhesive and the other printed face will be up.

The imaging device 130 will preferably be a sheet fed device that will include a supply of sheets 131 of a standard stock configuration. The supply of sheets 131 will be processed by the imaging device 130 in order to create graphical or textual depictions on the sheet 132 in predetermined select areas 134 that will define the templates, segments or surface elements when they are cut from the sheet. It should be understood that while preferably a number of sheets will be printed in connection with carrying out the present invention, only a single sheet may need to be produced in order to practice the invention.

The sheet 132 is then sent to a cutting device (not shown) which may include any mechanism suitable for cutting out the separate segments or elements from the sheet 132. The separate surface elements or segments are depicted by reference numerals 136. Each of the segments is shown with different indicia represented by numerals 137, 138 and 139. While only three segments have been shown as being produced from the sheet 132, it should be understood that the system can generate any number of segments as well as shapes. The number of possible segments does not vary proportionately with the size of the initial sheet stock, although a larger sheet stock will generally be capable of producing a larger number of segments.

Each of the individual segments 136 is then loaded into a hopper mechanism for the feeder or placer mechanism 140. An exemplary placer, feeder or insertion device is a Maverick® available from In-Line Automation of Minneapolis, Minn. The exemplary unit will use a vacuum cylinder to take the segments from the hopper and then deposit the individual segments sequentially on the surface of the web 110 over the adhesive 115 in a machine direction, represent by an arrow having an alpha designation “A”.

The segments 136 are shown placed on the web 110 by the placer mechanism 140 and then the web along with the surface elements travel to a collection point 145 which may be a rewinder, sheeter or other means suitable for collecting the intermediate pressure sensitive assembly of the present invention.

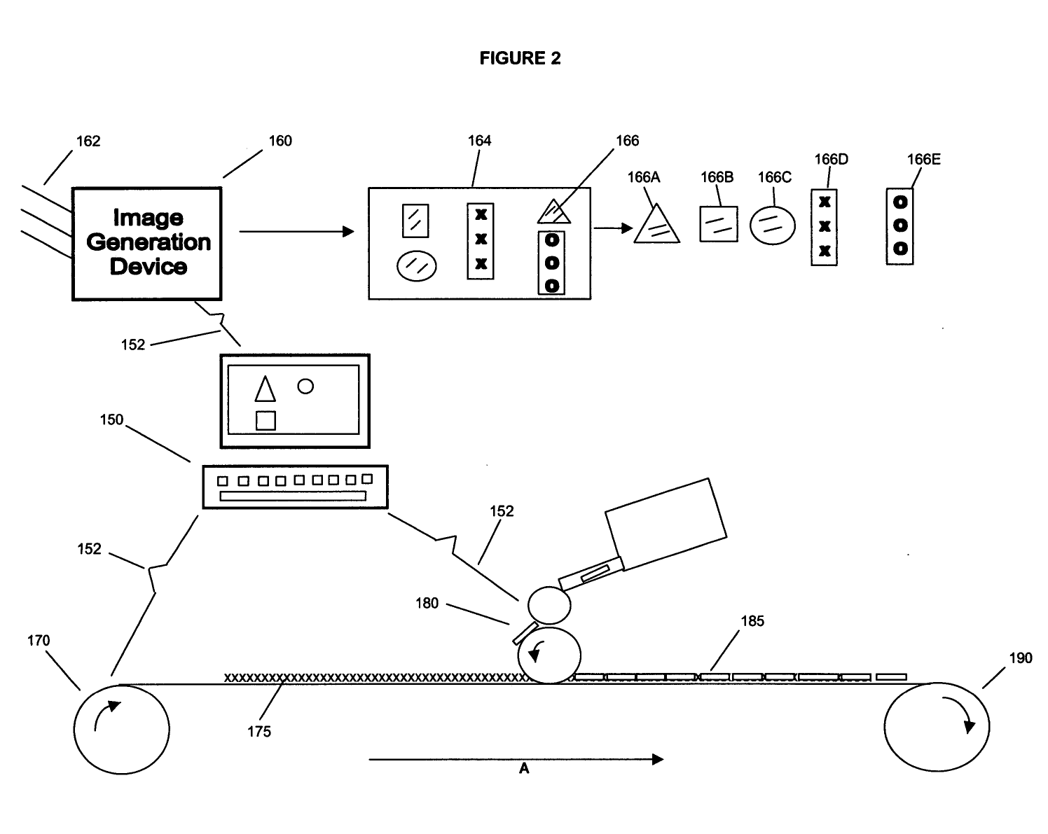

Reference is now directed to FIG. 2 of the invention which includes a further depiction of the system described herein. The system uses a computer 150 that can communicate through links or communication means 152 to a press 170 for handling a continuous web 175, an imaging device 160 and a placer mechanism 180. The computer may communicate only with each device, may communicate simultaneously with all the devices during the production of an order, or separate computer devices may be used for each of the devices or combinations of the devices.

A series of sheets 162 are fed to the imaging device 160 so that the imaging device can prepare the sheets for producing a number of discrete label segments or templates as represented by sheet 164 which has a number of different sized and shaped segments 166. As can be seen from the drawing, the sheet 164 is depicted as having a number of different shaped and sized elements. The system is capable of generating elements that are selected from geometric, animate, inanimate and combinations thereof.

The sheet 164 is then preferably sent to a die cutter (not shown) which separates the sheet into individual segments 166a, 166b, 166c, 166d and 166e. The step of die cutting can cleanly separate the segments into the shapes printed or may cut the sheets into ribbons that still contain the imaged portion as represented by 166d and 166e. In this configuration, the segments may undergo a further die cutting step after being placed on the web 175 by the placer mechanism 180 to trim the matrix portion from around the printed area that will make up the final segment, strip or template.

The individual segments 166a through 166e are then placed in a hopper for the feeder or placer mechanism 180. It is important to note that various sizes and shapes of segments can be placed in the hopper and be handled efficiently by the placer mechanism 180 of the present invention.

Each of the segments or surface elements are then applied to the web 175 as shown at 185 and then advanced to a collection point 190 where the web with the surface elements attached are collected.

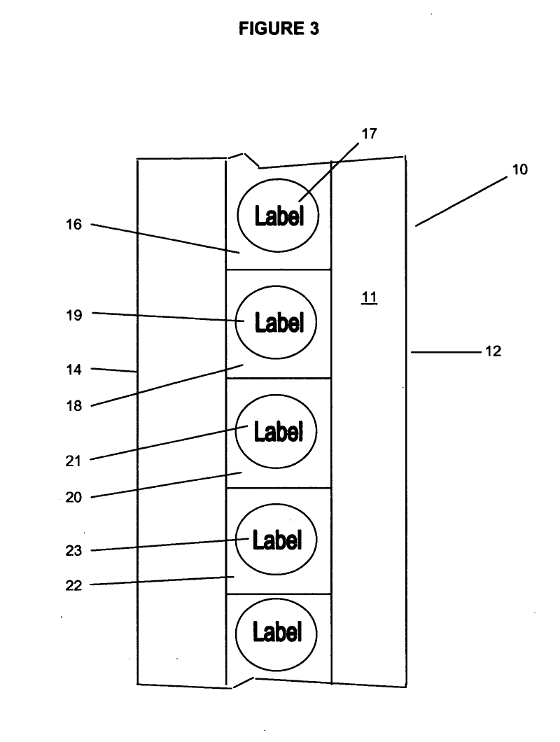

Attention is now directed to FIG. 3 which provides one exemplary embodiment of the intermediate pressure sensitive web assembly having a number of surface elements deposited thereon. The intermediate web assembly is generally designated by reference numeral 10 and includes a continuous web 11 having first and second longitudinally extending sides 12 and 14. A coating of release material has been provided and adhesive is placed in a pattern over the release as has been previously described in reference to FIGS. 1 and 2.

The web 11 is shown with labels 16, 18, 20 and 22 disposed between the first and second longitudinally extending sides. Each of the labels has a printed area 17, 19, 21 and 23 which will make up the portion of the label that is to be removed an applied in a particular application, such as applying a label to a consumer packaged good, carton or receptacle. The surrounding area to that the printed portion 17, 19, 21 and 23, is known as the matrix and will be die cut during a subsequent processing step to remove the matrix from the printed portion.

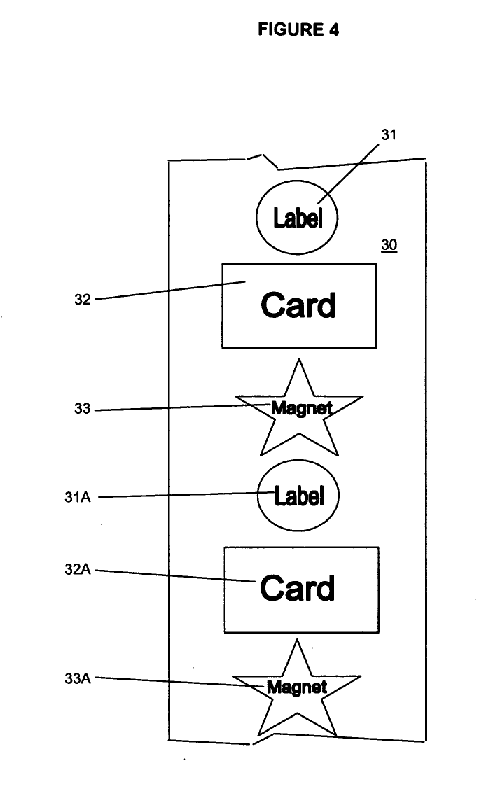

FIG. 4 represents still a further embodiment of the present invention and includes a repeating sequence of different sized web surface elements. The continuous web 30 has different elements placed on its first face and these elements include a label 31, card 32 and shaped magnet 33. The sequence then repeats itself with label 31a, card 32a and magnet 33a. In this way, unique marketing and business communication assemblies can be created to give the customer all of its needs in a continuous web format. Such an arrangement thus avoids the need to generate multiple webs, in this case three webs with each web carrying one type of substrate, e.g. one carrying labels, one cards and the third magnets. In addition, as the current system can produce all the elements in a sheet form, the imaging device ensures an equivalent quality of reproduction on each of the pieces.

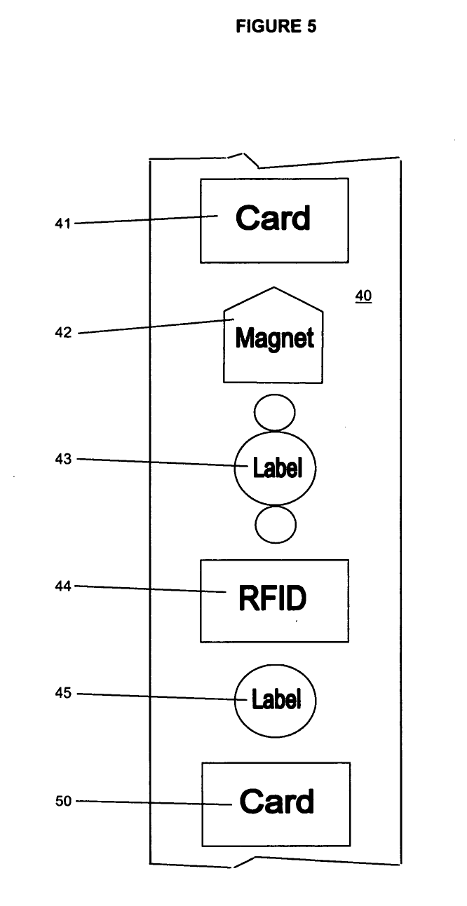

FIG. 5 provides a yet still further representation of the versatility and functionality of the present invention. In this embodiment a continuous web 40 is provided with a random pattern of surface elements including a card 41, shaped magnet 42, inanimate shaped label 43, RFID tag 44, geometric shaped label 45 and card 50. Through use of the present invention, web having significant diversity can be generated and can be used with an automated application system that will sense the type of element on the surface of the web for application to a particular surface or article.

One of the most important things with respect to new product innovations is the need to effectively market and communicate the new product to potential customers and end users of the product. Such marketing typically includes the creation of marketing collateral associated with the features of the present method and system and its benefits and uses. These unique products produced by the system and in accordance with the method of the present invention are sold in connection with that marketing collateral and then the end product is distributed to potential end users and customers or the technology is transferred to others for incorporation in their respective products. Customers can include distributors of such products as well as office supply stores, retail and warehouse outlets or manufacturers of such products which themselves may not be end users, but may repackage and resell the products to end users or third parties.

Marketing collateral for communicating business or marketing messages as used herein includes the use of scripted or prepared material that are distributed through audio and visual communication mediums, over a global communication network, through printed mediums such as newspapers, trade publications, magazines, fliers, handouts and the like.

The present invention further fulfills the need of the small to medium range market for prime labels, those quantities typically between 100 and 1,000,000 without requiring the payment of substantial premiums as may be necessary to offset the costs associated with traditional processes such as flexographic technology.

It will thus be seen according to the present invention a highly advantageous system and method for generating variable pressure sensitive intermediate webs has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A system for generating variable, intermittently laminated pressure sensitive webs, comprising;
a series of product imprint groups with each group having a number of pre-determined areas for receiving printing or imaging, each of said templates having an area and each of said group of templates are configurable from a sheet;
a computer for selecting at least one of said groups in connection with a request to produce a printed product, said computer determines a placement sequence for said templates and communicates with a web processing apparatus and a placer mechanism;
an imaging device for producing graphical and textual depictions in each area of each of said templates while said templates are in said sheet configuration;
a cutting mechanism for cutting said sheet into individual templates;
said web processing apparatus for handling a continuous web of material;
a placer mechanism; and
wherein said placer mechanism in response to a signal sequentially places each of said pre-printed templates in accordance with said placement sequence on said continuous web of material to create a web having a series of discrete templates serially laminated thereon.

2. A system as recited in claim 1, wherein said sequence of said pre-determined templates of said product imprint groups are label configurations.

3. A system as recited in claim 1, wherein said sequence of said pre-determined templates of said product imprint groups are plastic configurations.

4. A system as recited in claim 3, wherein said plastic configurations include cards, license plates, name plates, signs and combinations thereof.

5. A system as recited in claim 1, wherein said sequence of said pre-determined templates of said product imprint groups are magnetic configurations.

6. A system as recited in claim 1, wherein said sequence of said pre-determined templates of said product imprint groups includes at least two different product groups selected from plastic, magnetic, labels, cards, foils, films and combinations thereof.

7. A system as recited in claim 1, wherein said system includes a verification mechanism to confirm placement and accuracy of each of said templates on said continuous web.

8. A system as recited in claim 1, wherein said system creates a random placement sequence of templates for application to said continuous web.

9. A system as recited in claim 1, wherein said system creates a regular placement sequence of templates for application to said continuous web.

10. A system for creating a pressure sensitive laminate web having multiple discontinuous surface elements, comprising;
a continuous web processing apparatus for handling a continuous web with said continuous web having a release coating and pattern of adhesive disposed over said release coating, said continuous web processing apparatus is used to advance said continuous web in a machine direction and through at least one processing station;
an image generating device for applying imaging or printing to a sheet of stock material, said image generating device is programmed to render discrete areas on said sheet to create individual elements that will be cut from said sheet and applied to said continuous web;
a series of previously prepared surface elements, with each of said elements having imaging or printing applied thereon and said surface elements are cut from said sheet of stock material after printing or imaging;
a placer mechanism for applying each of said surface elements to said continuous web while said web is handled by said continuous web processing apparatus; and
wherein said placer mechanism sequentially places each of said surface elements on said continuous web to create a pressure sensitive laminate web having discrete, discontinuous surface elements applied thereto.

11. A system as recited in claim 10, wherein said system includes a computer for communicating with said placer mechanism and said continuous web processing apparatus and wherein said computer creates a placement sequence for said surface elements for position said surface elements on said web.

12. A system as recited in claim 11, wherein said system generates a regular pattern of surface elements for said placement sequence.

13. A system as recited in claim 12, wherein said system generates a random pattern of surface elements for said placement sequence.

14. A system as recited in claim 11, wherein said surface elements are selected from a group including paper, film, magnetic material, plastic, foils, synthetic stock and combinations thereof.

15. A system as recited in claim 12, wherein said regular pattern of surface elements includes repeating paper elements suitable for use as prime labels.

16. A system as recited in claim 13, wherein said random pattern of surface elements includes elements having different substrates from one another and said random pattern is used in connection with a marketing campaign.

17. A system for creating a pressure sensitive web having a number of individual sheet segments affixed to a continuous web, comprising;
a web processing device for handling a continuous web, said continuous web having first and second faces and first and second longitudinally extending sides and a release coating applied between said first and second longitudinally extending sides and on said first face, said continuous web further having a pattern of adhesive applied over said release coating to create a pressure sensitive web assembly;
an image generating device for printing or imaging graphical depictions on a surface of a sheet of material in discrete areas with each of said areas defining individual sheet segments;
a cutting device for cutting said sheet into individual sheet segments after said sheets have been printed or imaged;
a placer mechanism for sequentially depositing said individual sheet segments on said continuous web in connection with a signal between said first and second longitudinally extending sides of said continuous web; and
wherein said sheet segments are placed on said continuous web by said placer mechanism to create a pressure sensitive laminate continuous web having pre-printed, separate sheet segments applied to said first face of said continuous web.

18. A system as recited in claim 17, said system applies said sheet segments in a pattern on said continuous web, said pattern selected from a group including random, regular, irregular and combinations thereof.

19. A system as recited in claim 17, wherein said sheet segments are selected from a group including paper, film, magnetic material, plastic, foils, synthetic stock and combinations thereof.

20. A system as recited in claim 17, wherein said signal is generated by a computer and said computer communicates with at least said placer mechanism and said continuous web processing apparatus.
